(19) United States
(12) Patent Application Publication
(10) Pub. No.: US 2006/0022819 A1
(43) Pub. Date: Feb. 2, 2006

(54) Device and implementation method for citizen notification in well defined geographic regions of homeland security and/or civil defense warnings, alerts and desired protective actions

(76) Inventors: Nicola Vincent Granny, Bloomington, IN (US); Martina Maria Brisudova, Bloomington, IN (US)

Correspondence Address: Nicola V. Granny, 1194 E. Winners Cir., Bloomington, IN, 47401, US

(21) Appl. No.: 10/899,814

(22) Filed: Jul. 27, 2004

(51) Int. Cl. G08B 1/08; G08B 29/00

(52) U.S. Cl. 340/539.17; 340/506

(57) ABSTRACT

A device, of compact dimensions, and method that enables Public Safety agencies to issue geographically specific alerts to which the device responds. Alerts include complex alert area boundary data interpreted by the device. The device responds only to alerts germane to the its installed location. When activated, the device annunciates alerts using lights, tones, speech, and text, indicating the alerts' nature and desired citizen action. The invention augments the national EAS system capabilities using existing digital paging or digital subscription data infrastructures that broadcast the alerts using FM subcarriers. The invention further: a) does not require citizen participation or maintenance beyond acquisition and installation, b) does not require skilled use, c) is multilingual, d) provides annunciation sufficient to awaken sleeping people, e) is always on, f) is economically manufacturable, g) is in-field upgradeable.

### FIELD OF THE INVENTION

The invention is primarily involved in the field of Homeland Security in the context that has, more traditionally, been known as Civil Defense—Emergency Warning.

### BACKGROUND OF THE INVENTION

The events of the “9/11” terrorist attacks upon the United States demonstrated that our existing infrastructure for Public Safety Alert and Warning Notification is inadequate. Now, as nations face the very real threat of nuclear, biological and chemical (NBC) acts of terrorism, in addition to the “traditional” Civil Defense problems, the need for a fast, accurate and easily understood alert system is even more readily apparent.

Significant problems for Homeland Security/Civil Defense (hereafter HSCD) agencies are that the current Emergency Alert System (EAS) is not, at the citizen level: a) universally available, b) fully automated or, c) sufficiently geographically specific. As implemented, the EAS allows HSCD agencies to broadcast alert information within county-sized areas (typically 78 square miles for a low-power FM radio station) with significant electronic spillover to adjacent counties. While this is marginally acceptable for things like tornado or hurricane alerts it offers too much opportunity for widespread panic in the event of a more constrained emergency, such as a “dirty bomb” or chemical attack. Current EAS mechanisms are inadequate in very dense urban areas, since geographically non-specific alerts, especially evacuation alerts, may have collateral consequences (panic, gridlock, blocking emergency services, etc.) that can be as damaging to the population as the root cause of the alert. Additionally, tornado alerts are more effective when pinpointed to areas actually in the projected storm track and not broadcast over very large areas.

In 1997 the Federal Government with the concurrence of all states and territories replaced the Emergency Broadcast Service with the modernized, more fully featured Emergency Alert System (EAS). The new technology of the EAS includes features that allow specially equipped receivers to automatically “power-up” and allow the target population to hear the emergency messages. The current EAS system also includes features that allow the broadcast station to perform its EAS network function in completely automated manner. In addition to EAS, virtually the entirety of North America has broadcast FM subcarrier based paging or subscription information distribution capabilities. These significant improvements in alert mechanisms and information distribution form the enabling technologies and basis for cost effectiveness for this invention.

The invention solves the problems summarized in paragraph [002] by making available an inexpensive device that provides an extremely high degree of geographic specificity with fully unattended operation. Its physical similarity to traditional domestic smoke detectors makes its deployment unobtrusive without a loss of in effectiveness. Since the device makes use of existing infrastructures it may be rapidly deployed without the need for substantial governmental capital investment or training of emergency services personnel.

### BRIEF SUMMARY OF THE INVENTION

The invention consists of two devices:
1. public Alert Receiving Device (ARD)
2. Homeland Security/Civil Defense Agency Alert Encryption Device (AED).
   The invention relies on three underlying technologies:
1. Single Low Power Integrated Circuit FM Receiver-Decoder
2. Single Integrated Circuit Embedded Computer/Memory
3. EITHER/OR
   a. Broadcast FM subcarrier digital paging service
   b. Broadcast FM subcarrier digital subscription information service
      NOTE: Because the underlying electronics for both digital paging services and digital subscription information services is similar, for reasons of clarity this specification uses digital subscription information services as the explanatory medium. When manufactured, the invention may be fabricated using both technologies and distributed based on the service available within the end-users locality.

The ARD is a physically compact electronic device consisting of an FM (Frequency Modulation) radio receiver operating in the 88 MHz to 100 MHz (commercial FM broadcast) band with an embedded microprocessor and associated support electronics supporting the subscription information service protocol (1-001). The ARD is manufactured in two mounting versions, a “hard-wired” version that is physically and permanently connected to a building's electrical supply or a “plug-in”, relocatable version. Both versions include a rechargeable Li-ion battery pack. The device includes a piezoelectric audio transducer for producing audible alerts and a single blinking white strobe, two-line liquid crystal text display (LCD) and a speaker for speech annunciation. For use in below ground level installations a facility for an external antenna is included.

In addition to the ARD's FM radio receiver it also contains a small secure circuit that decrypts the alert message and a logic core that interprets the alert message, determines if the receiver is within the target geographic area and processes the alert. Additional details concerning the physical design of the device hardware and software are included in later sections of this specification.

The mechanical aspects of the ARD installation (unpacking and physical mounting) are unremarkable and not discussed in this specification. Prior to attaching the electronics module of the ARD to AC power, the end-user contacts a centralized registration facility, assumed to be operated by the inventor or an authorized contractor, through the use of either a web site or a toll-free telephone number. The end-user provides only the physical address where the ARD is to be installed. The registration facility provides the end-user with the location (encrypted latitude and longitude information) code numbers for that installation site. The registration agency records the location of the device for statistical analysis and system test purposes (defined later in this specification). Additional ARD's at the same physical address do not require specific registration; they all will use the same data as the registered ARD.

The end-user sets the location binary (or HEX) switches to the settings provided by the registration facility and attaches the ARD to the mounting plate.

When an emergency situation occurs, the appropriate HSCD agency may determine to use a general broadcast or a geographic specific broadcast of alert information. If a geographic specific broadcast is desired, the latitude and longitude of each vertex in the alert areas boundaries are determined by the HSCD agency by using a mapping program (e.g. Microsoft MapPoint) supplied with the encoding software. The HSCD agency is provided with an alert encryption device (EAD) which is a portable electronic key accessed by the EAD software that creates a password protected, encrypted data stream that is to be transmitted on a subcarrier by the EAS broadcast station(s) using the regionally desired transmission protocol. This data stream includes the geographic boundaries and the alert message to be used as well as the alert message code and citizen action code.

The HSCD agency then activates the EAS system (if needed) and transmits the encrypted alert message. The digital alert message form the AED travels over the Internet to the digital data subscription services dispatch center which repackages and validates the alert and forwards it to the desired broadcast facilities. At the broadcast station, which is equipped to transmit the regionally desired protocol, the encrypted alert signal is transmitted along with all other routine datagrams. Since only the ARD's are equipped to translate the alert messages, other protocol-enabled devices (pagers, subscription information receivers, etc.) will not unnecessarily display information.

When the ARD receives an EAS alert it first decodes the data stream and determines its validity based on the password. If the message is determined to be valid, it then passes the message to the logic core.

The logic core determines if the physical location of the device is within the bounding rectangle broadcast. If the ARD is within the targeted area the device activates and annunciates the alert. If the device is not within the targeted area, the alert is ignored.

Upon receipt of an “all clear” alert, the ARD would reset annunciators and return to its quiescent, monitoring state. In some cases (such as test messages or all clear messages) the ARD will automatically return to the quiescent, monitoring state after a specific amount of time has passed.

### BRIEF DESCRIPTION OF THE DRAWINGS

FIG. 1: Block diagram of the Alert Receiving Device (ARD).

FIG. 2: Table of supported alert messages

FIG. 3: Logic core software flow chart (four pages: 3a, 3b, 3c and 3d)

FIG. 4: Encryption console (AED) software flow chart

FIG. 5: Encryption console (AED) user interface (screen shot)

FIG. 6: Encrypted message packet

### DETAILED DESCRIPTION OF THE INVENTION

Detailed Description of the Public Alert Receiving Device (ARD)

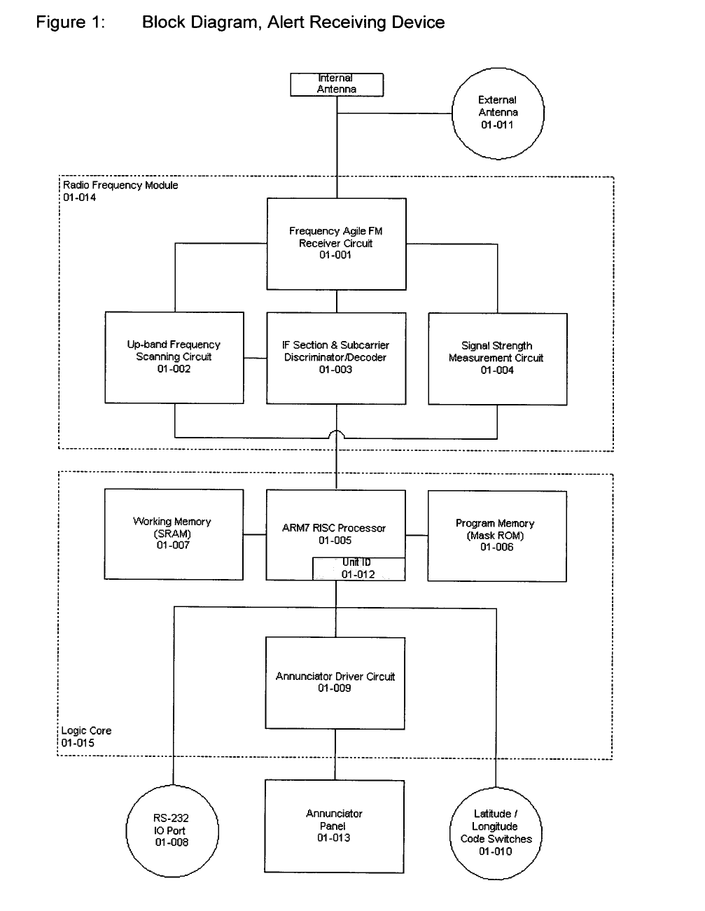

The ARD is a compact, inexpensive electronic device similar in size and appearance to a typical residential smoke detector or digital alarm clock. The ARD contains the electronic elements shown in FIG. 1.

It should be noted that, excluding the power and annunciator circuits, the ARD's electronics are contained within a single protocol specific chipset mounted on a small, single sided printed wiring board (PWB). Since the chip set for both the digital paging and digital subscription information service protocols are commercially available items, the details of their theory of operation and construction are not included in this specification and/or disclosure.

The FM front-end (01-014 Radio Frequency Module or RFM) of the ARD is made from the RF portion of the protocol specific subcarrier receiver chip set. For most aboveground installations the internal antenna (FIG. 1) is used. Where the signal strength would be unacceptably weak (the center of large buildings or belowground installation, an external antenna (01-011) is connected to the base plate.

The RFM includes a frequency agile FM receiving circuit (01-001) that continuously receives signals in the commercial FM broadcast band of 88 MHz to 108 MHz. The primary carrier frequency is not user settable and is determined automatically by other circuits in the chip set.

The IF Section & Subcarrier Discriminator/Decoder circuit (01-003) determines if the current primary carrier frequency includes a subcarrier that has the regionally appropriate data embedded within. If the expected subcarrier is not detected the Up-band Frequency Scanning Circuit (01-002) switches the receiver to the next higher valid frequency. This process repeats until a suitable subcarrier is detected.

When a suitable subcarrier is detected, the frequency and signal strength, measured by the Signal Strength Measurement Circuit (01-004) are passed on to the Processor (01-005).

The frequency scanning process is repeated until the entire 88 MHz to 108 MHz band has been scanned and the station with the strongest signal identified. This strongest signal carrier frequency is then locked into the receiver circuit until such time as either: a) the signal strength drops to an unacceptably low level or, b) the signal is interrupted. If either condition (a) or (b) occurs, the scanning process is performed again.

The logic core (01-015) consists of the processing portions of the regionally appropriate protocol chip set. The processor itself is an ARM7™ RISC processor and related program and data memory. The RISC processor, at the time of manufacture, is given a 128-bit ID code (01-012); this code is specific to the invention and is kept absolutely private. The purpose of the ID code is to provide the processor with a mechanism for differentiating subcarrier encoded messages that are intended for other protocol enabled devices and alert/warning messages intended for the invention. The processor will not respond to any message not addressed to the specific device ID code. This, combined with other security features defined later, makes it extremely difficult (nearly impossible) for an unauthorized person or organization to transmit unauthorized alerts and/or warnings.

When an ARD encoded message packet is passed to the processor (01-005), it is first validated against the device ID code (01-012) and if validated at this level, it is passed on for further processing. The device ID code is embedded in the transmitted packet header (FIG. 6).

All ARD message packets contain a time stamp field embedded in the packet header (FIG. 6). The time stamp field, along with the broadcast password embedded in the message packet, is used by the processor to determine the authenticity of the message. The only way to generate an authentic password is to have access to a properly registered Agency Encryption Console that has the hardware key and the separate user password provided at registration time by the registering agency (assumed to be the Department of Homeland Security). The alert message must be originally encrypted within one minute of the time it is received by the Alert Receiving Device to be considered authentic, even if the mechanism of encryption is valid: a “late” message is ignored.

If the alert message is determined to be timely and authentic, the processor then reads the geographic location codes from the message (FIG. 6) to determine the geographic boundaries of the area of the alert. It is important to note that the location codes are not actually binary representations of the latitude and longitude of the vertices; rather, they are encrypted code values that the processor decodes. Likewise, the location switches that define the devices geographic location are encoded. This feature further complicates the ability of an individual or organization to transmit unauthorized alerts or warnings. The processor then decodes the settings of the location switches and determines if the ARD is physically located inside the alert geographic area.

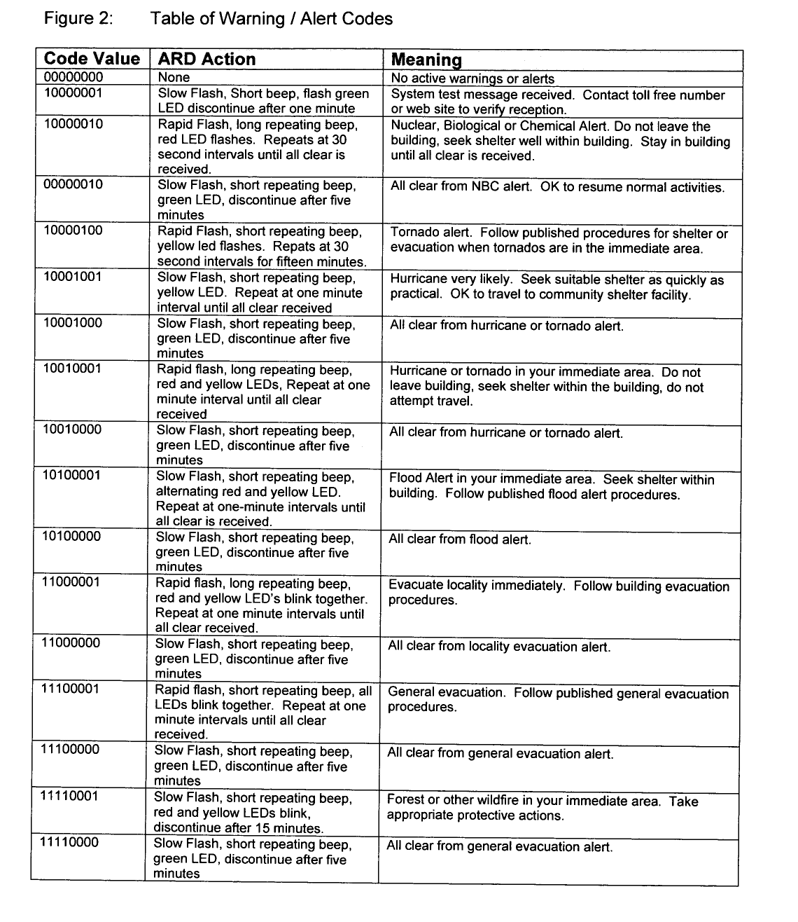

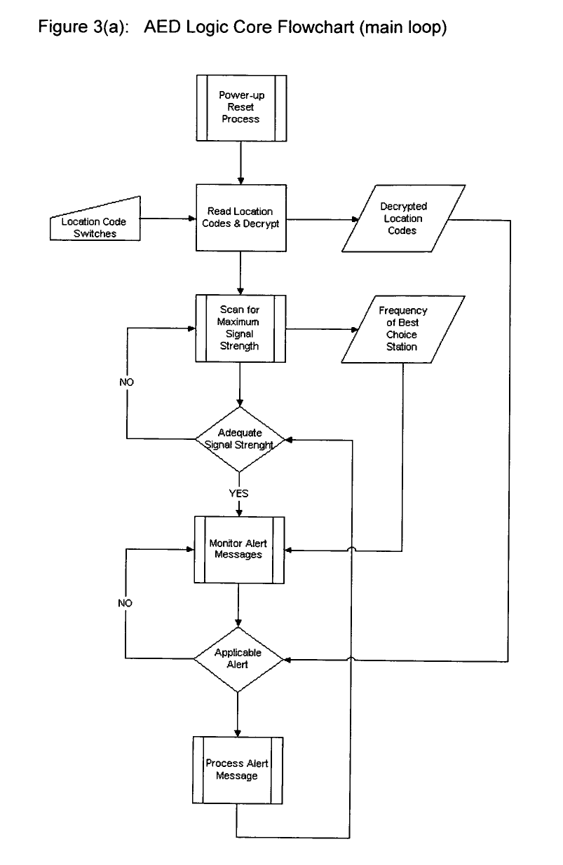

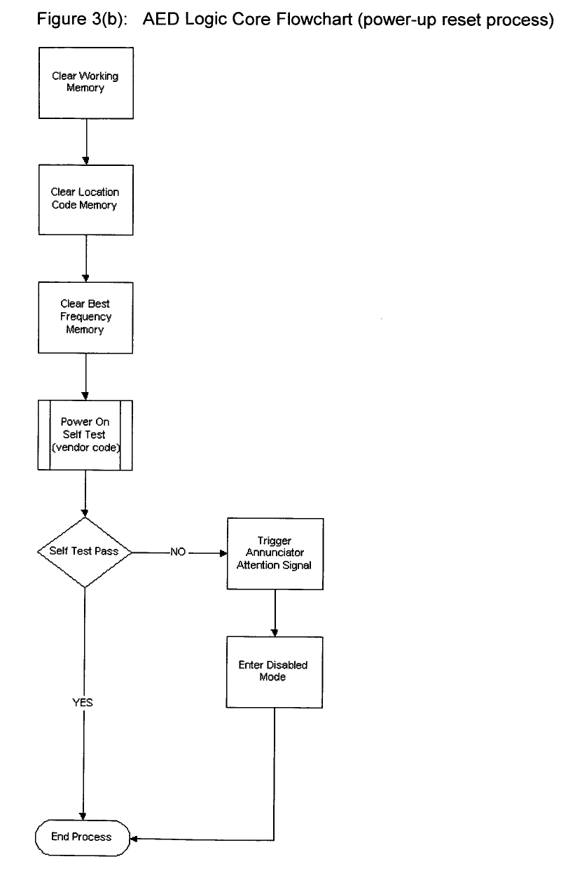

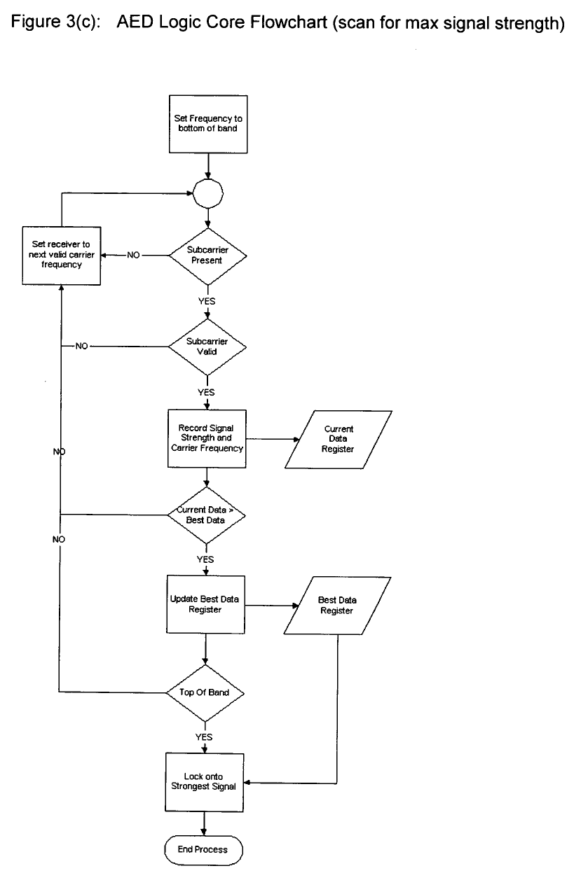

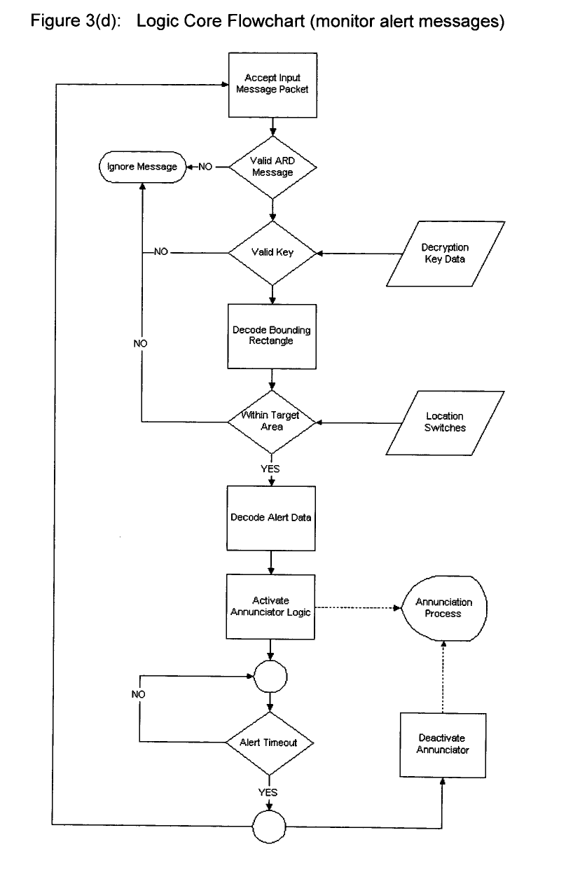

If the processor determines that the ARD is not physically located in the alert area, the message is ignored. If the processor determines that the ARD is physically located inside the boundaries of the alert area, then the payload of the message is decrypted and the appropriate annunciator action is initiated. Refer to FIG. 2 for a table of supported warnings and alerts. Refer to FIG. 6 for the location of the message type within the message body.

The annunciator section (01-013) is a simple circuit board that accommodates a low voltage strobe light (flash) and a multi-line text LDC that indicate the nature of the alert. The annunciator section also accommodates a piezoelectric acoustic transducer that is used to emit a loud audible alert that varies with the type of alert message received and a speaker for speech annunciation. When the ARD is purchased, the end-user may select an optional language module making the ARD “bilingual”.

The annunciator includes simple logic in the form of a PAL (programmable array logic) device that responds to 8-bit codes from the logic core (01-015) and produces the appropriate audible-visible actions. Codes for the alphanumeric (optional) display are stored in a small ROM on the annunciator board. Since the annunciator does not include any unique or novel design or technology no addition amplification is included in this specification.

The mechanical elements of the ARD include a base plate that may be wall or ceiling mounted that includes connections for 90VAC to 240VAC, 50 Hz to 60 Hz power and an external antenna connection for below ground level installations. The active electronics are housed in a sealed plastic cover that connects to the base plate. The cover has a single user operable opening that allows access to the location code switches. The ARD will also accommodate a purely battery powered configuration, when connection to AC power is either unavailable or inappropriate (e.g. explosive physical environments).

Detailed Description of the Alert Encryption Device (AED)

The AED is a combination of hardware (key) and software intended for use with a personal computer having a standard printer port. The computer may run any commonly encountered operating system.

A hardware key (such COTS (commercial off the shelf) keys are readily available) is connected to the printer port (the printer cable may then be connected to the hardware key). A program is executed that uses a combination of the hardware key and a password obtained from the central registration agency to encrypt the alert data stream.

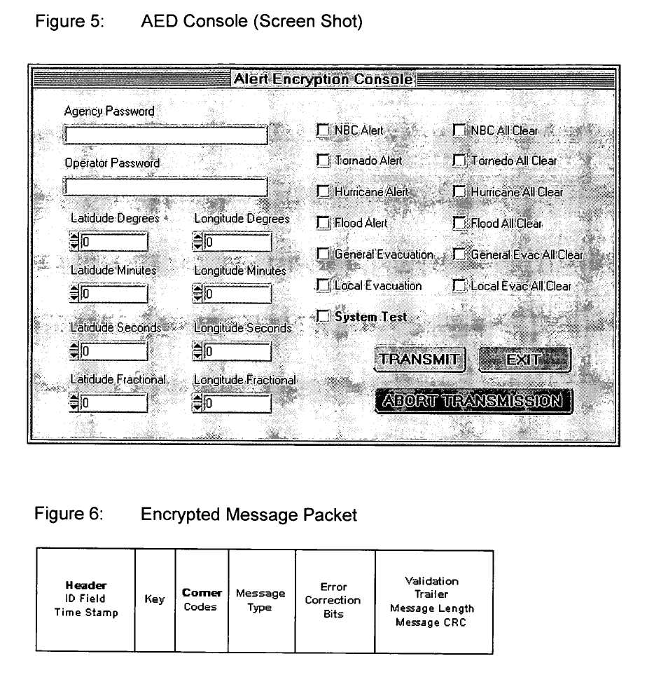

The AED operator then enters the latitude and longitude of each corner of the alert area geographic boundaries and selects a “radio button” to indicate the desired alert message. FIG. 5 illustrates the AED user interface.

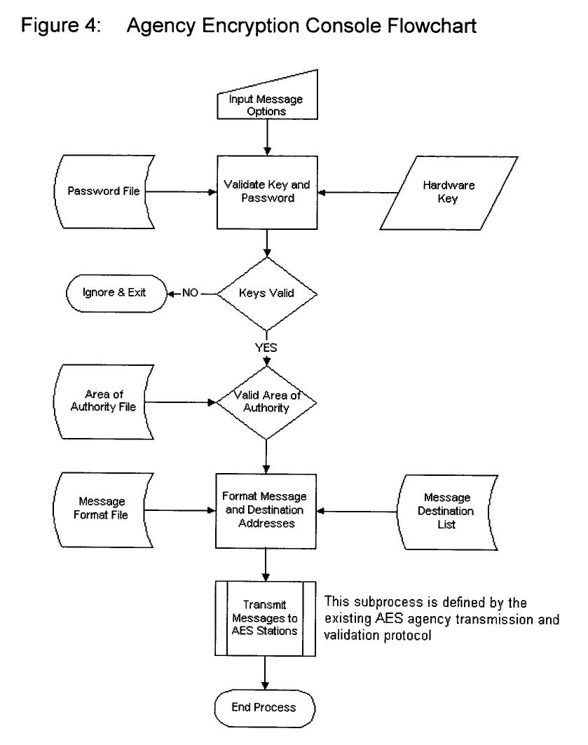

The software accepts the operator entry for the operator password as well as the agency password (FIG. 6). The operator password validates the authority of the operator to initiate an alert. The agency password validates the authority of the agency to issue an alert for the defined geographic region. The data for the regional allocations comes from the Authority file (FIG. 4). The validity of the agency and operator password is determined algorithmically.

Because patent applications and awarded patents are publicly available information the mechanism for encrypting, decrypting and validating passwords and location codes is not included in this specification. A 128-bit encryption/decryption algorithm is used.

The resulting data stream is then forwarded to the EAS broadcast stations for transmission to the individual ARD's using the existing EAS data distribution mechanism(s) (FIG. 5).

1. A device that provides a mechanism to distribute (transmit) and accept (receive) geographically specific warnings and alerts pertaining to matters of Homeland Security and/or Civil Defense and/or local or regional public safety, including but not limited to: nuclear-biological-chemical attack, tornado, hurricane, sever weather, flood, fire, earthquake, local evacuation, area evacuation, “Amber Alerts”, etc.

2. A device that validates the integrity of broadcast warnings and alerts pertaining to matters of Homeland Security and/or Civil Defense and others defined in claim 1 (above).

3. A device for receiving geographically specific warnings and alerts that does not require active end-user actions beyond initial installation and battery replacement.

4. A device that provides audible and/or visual indication of Homeland Security and/or Civil Defense or other Public Safety warnings and alerts, including but not limited to: strobe light, LED indicators, piezoelectric annunciator, alphanumeric display, speech synthesis, etc.

5. A device and method for generating geographically specific Homeland Security and/or Civil Defense and/or Public Safety warnings and alerts using secure encryption and decryption methods and practices.

6. A set of devices and methods that allows geographic resolution of Homeland Security and/or Civil Defense and/or Public Safety warnings as fine-grained as individual street addresses in any area for which conventional or digital maps of sufficient resolution exist or may eventually exist.

7. A set of devices and methods for implementing claims 1 through 6 (above) that does not require significant investment on the part of either the Government or commercial broadcast stations in additional systems and capabilities.

8. A device and method for implementation that allows for geographically specific alert systems testing and monitoring of statistical distribution of alert devices.

9. A device for annunciation of geographically specific warnings, alerts or other information in public spaces.

10. A device for annunciation of geographically specific warnings, alerts or other information in transportation facilities.

11. A device for annunciation of geographically specific warnings, alerts or other information in moving vehicles, vessels or other conveyances where location information is derived from GPS provided information.

12. A device for the distribution of geographically specific information provided through broadcast radio and or television, independent of the broadcast media (e.g. conventional broadcast, cable distribution or satellite broadcast).
